(19) United States
(12) Patent Application Publication
(10) Pub. No.: US 2026/0280155 A1
(43) Pub. Date: Sep. 17, 2026

(54) GROUNDING CLAMP FOR ENHANCED GRIPPING OF CONDUCTORS

(71) Applicant: Tallman Equipment Co., Columbus, IN (US)

(72) Inventors: Andrew F. Finn, Elmhurst, IL (US); Sara E. Hassell, Oakbrook Terrace, IL (US); Edward F. Youngerman, St. Charles, IL (US)

(73) Assignee: Tallman Equipment Co., Columbus, IN (US)

(21) Appl. No.: 19/079,004

(22) Filed: Mar. 13, 2025

(51) Int. Cl. H01R 4/36

(52) U.S. Cl. CPC H01R 4/366

(57) ABSTRACT

A grounding clamp includes a grounding clamp body having a threaded receiving portion, at least one grounding terminal having a through-hole for receiving a grounding wire, and a frame having a spine portion. The grounding clamp body further includes a jaw connected to the spine portion, and the jaw having a hook portion extending outwardly to a terminal tip. The grounding clamp body further forms a wire clamping pocket extending between the spine and the hook portion, and including a wire seating surface forming a V-shape. Related methodology for making a grounding clamp is also disclosed. blank body

### TECHNICAL FIELD

The present disclosure relates generally to electrical servicing equipment, and more particularly to grounding clamps equipped to accommodate a variety of conductor sizes.

### BACKGROUND

Grounding clamps can be used to connect electrical conductors such as power lines, transformers, and relays, to ground for various reasons, such as for safety and fault protection. These grounding clamps operate such that in the event of a fault or electrical surge, the electrical energy can be safely directed to the ground. A variety of clamps or strategies exist for directing this electrical energy to the ground, typically catered for specific conductor sizes or materials.

One current design uses a generally arcuate surface which can be used to cradle conductors for clamping. Such designs have worked well for many years, but may have certain shortcomings relative to some applications. Another challenge with existing grounding clamps can be a limited ability to effectively accommodate all conductors that may be encountered in the field. One known grounding clamp can be seen in commonly owned U.S. patent application Ser. No. 18/122,231 to Galligar et al. While the '231 application concepts may offer advantages and prove useful in many applications, there is always potential for further improvements and/or development of alternative strategies.

### SUMMARY

In one aspect, a grounding clamp includes a grounding clamp body including a threaded receiving portion, at least one grounding terminal having a through-hole for receiving a grounding wire, and a frame having a spine portion. The grounding clamp body further includes a jaw connected to the spine portion, and the jaw having a hook portion extending outwardly to a terminal tip. The grounding clamp body further forms a wire clamping pocket extending between the spine and the hook portion and including a wire seating surface forming a V-shape.

In another aspect, a grounding clamp includes a grounding clamp body having a first jaw, a threaded receiving portion, at least one grounding terminal, and a second jaw structured to cooperate with the first jaw to clamp a conductor therebetween. The first jaw includes a wire seating pocket opening toward the second jaw, and a wire seating surface within the wire seating pocket and connected to a first side pocket surface and a second side pocket surface. The wire seating surface defines a radius less than 0.625 inches.

In still another aspect, a method of making a grounding clamp includes extruding a material through a die to form an extrusion body having a shape including a jaw portion and a pocket portion. Making the grounding clamp also includes forming from the extrusion a grounding clamp blank, and forming a profile of the pocket portion in the grounding clamp blank so as to include a wire seating surface defining a radius less than 0.625 inches. Making the grounding clamp also includes machining the grounding clamp blank so as to form a grounding clamp body having a first jaw and a wire clamping pocket that includes the wire seating surface, and installing a threaded rod coupled to a second jaw in the grounding clamp body.

### BRIEF DESCRIPTION OF DRAWINGS

FIG. 1 is a side view of a grounding clamp gripping a conductor, according to one embodiment;

FIG. 2 is another side view of the grounding clamp shown in FIG. 1 gripping a smaller conductor, according to one embodiment;

FIG. 3 is a portion of a grounding clamp, according to one embodiment;

FIG. 4 is a side view of a grounding clamp, according to another embodiment;

FIG. 5 is portion of a grounding clamp gripping a conductor, according to one embodiment;

FIG. 6 is a perspective view of a portion of the grounding clamp shown in FIG. 5, according to one embodiment

FIG. 7 is an enlarged view of the grounding clamp shown in FIG. 5, according to one embodiment; and

FIG. 8 is a diagrammatic illustration of a grounding clamp during fabrication.

### DETAILED DESCRIPTION

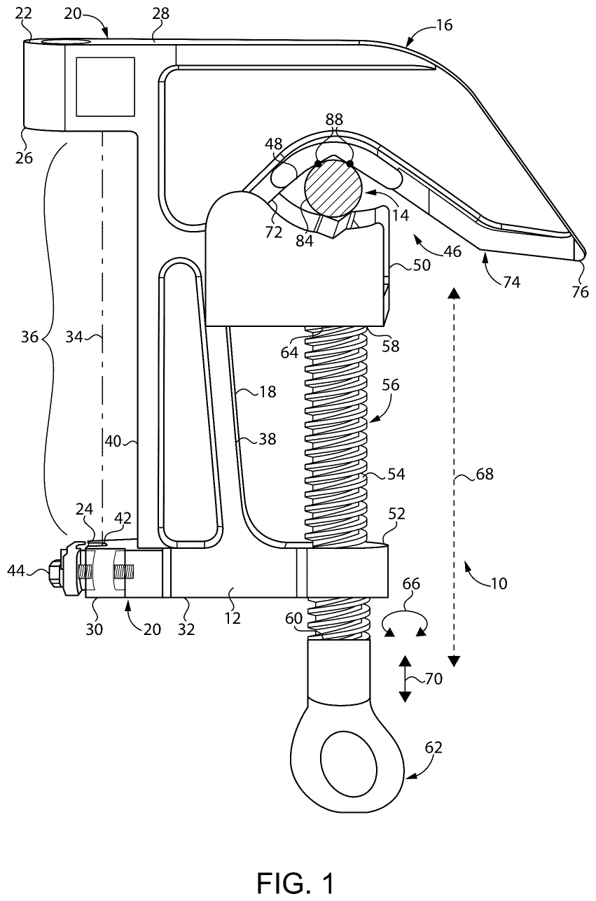

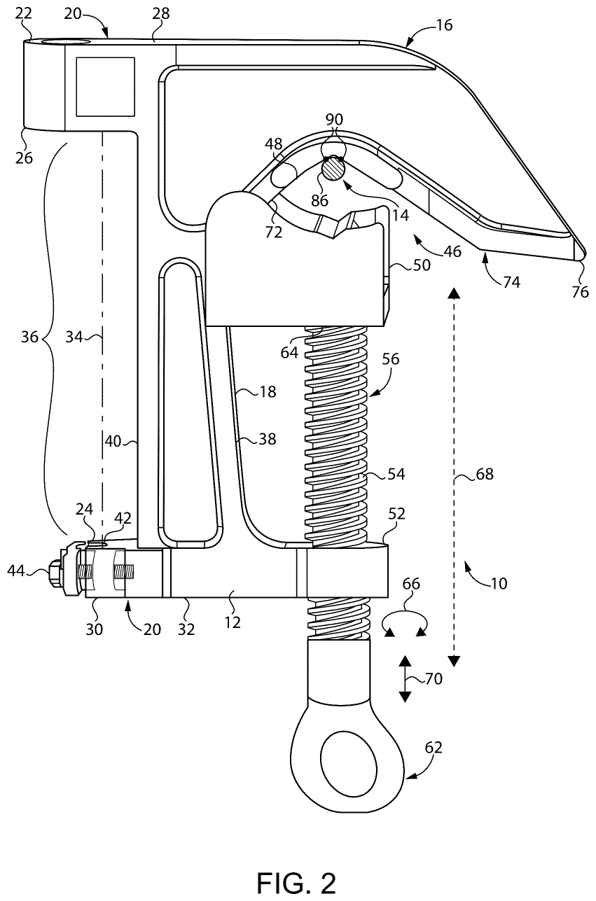

Referring to FIGS. 1 and 2, there is shown a grounding clamp 10 according to one embodiment. Grounding clamp 10 may include a grounding clamp body 12 and may be suitable for use in a range of electrical applications where grounding of a conductor 14 is required, for example, during servicing overhead electrical wires or various activities at electrical installations or power distribution systems. Grounding clamp 10 is designed to connect to conductors 14 such as wires, cables, or potentially other conductors, and may be formed of aluminum, or potentially other suitable metallic materials including alloys. Grounding clamp 10 may also be fabricated from a single material including a one-piece, monolithic body, and may be formed by an extrusion process.

Grounding clamp body 12 includes a frame 16 having a spine portion 18, and at least one grounding terminal 20 coupled to spine portion 18 for attaching a grounding conductor line (not shown) to grounding clamp 10. It should be appreciated that grounding terminals 20 may include a ferrule-style connection 22, a clamp style connection 24, or other suitable structure for attaching a grounding cable. Grounding terminals 20 can be positioned at various locations along spine portion 18, and may vary in both number and placement. For example, as shown in FIG. 1, a first grounding terminal 26 may be located at a first clamp end 28, and a second grounding terminal 30 may be located at a second clamp end 32 forming a clearance 34 defining a clearance distance 36 therebetween.

Spine portion 18 may also include an inner spine surface 38, and an outer spine surface 40 extending a length of clearance distance 36. In a practical implementation, grounding terminals 20 may also include a through-hole 42. Through-hole 42 may be used for mounting or attaching grounding clamp 10 to a conductive component. Grounding clamp body 12 may also include a grounding fastener 44, such as a bolt or screw, structured to secure the grounding wire within through-hole 42, and strategically positioned on grounding clamp 10 to provide a fixed mechanical and electrical connection. Terms such as “wire,” cable,” and “conductor” are used generally interchangeably herein, and no limitation is intended by way of the use of any particular one of these terms.

Grounding clamp body 12 also includes at least one jaw 46 connected to spine portion 18. In a practical implementation, grounding clamp 10 may include a first, upper jaw 48 structured to cooperate with a second, lower jaw 50 to clamp a conductor therebetween. Each jaw 48,50 may be structured to accommodate a range of conductor sizes, from smaller gauge conductors to larger cables. In yet another practical implementation, second jaw 50 may be structured to abut or extend beyond inner spine surface 38. Grounding clamp body 12 further includes a threaded receiving portion 52. Threaded receiving portion 52 can have internal threads sized and configured to matingly engage threads 54 on a threaded rod 56. Single-start or multi-start threads may be used.

Threaded rod 56 is structured to be passable through threaded receiving portion 52, so as to move the position of second jaw 50 relative to first jaw 48. Threaded rod 56 includes a first rod end 58, a second rod end 60, and a coupling eye 62 sized and configured for coupling with a rod or other tool for rotating threaded rod 56, for example. Threaded rod 56 may be structured to couple to second jaw 50 at an end opposite coupling eye 62, such that second jaw 50 is movable along and parallel to a portion of clearance distance 36 between a fully opened position and a fully closed position. As shown, threaded rod 56 is journaled in second jaw 50, optionally with a bearing 64. Threaded rod 56 can be rotated in a first direction 66 about a clamp axis 68. Rotation of threaded rod 56 in an opposite direction facilitates linear movement of the rod in a second direction 70 along the clamp axis 68, moving second jaw 50 relative to first jaw 48. In yet another practical implementation, grounding clamp 10 may also include a frame capture feature 72 which allows second jaw 50 to fit and slide on along frame 16, typically in a guided or slotted manner. This mechanism could include grooves, a track, a notched area, or still something else on second jaw 48 that corresponds to a matching component shape on frame 16.

Grounding clamp body 12 also includes a hook portion 74 connected to first jaw 48, and extending outwardly to a terminal tip 76. Hook portion 74, can be sized and configured to allow for grounding clamp 10 to more easily be guided onto a conductor. It should be noted that although hook portion 74 is angled and extends, in profile, axially downward and radially outward relative to clamp axis 68, other configurations are contemplated. Hook portion 74 could also form a curve or could include a retaining feature, to facilitate in capturing conductors 14 during use.

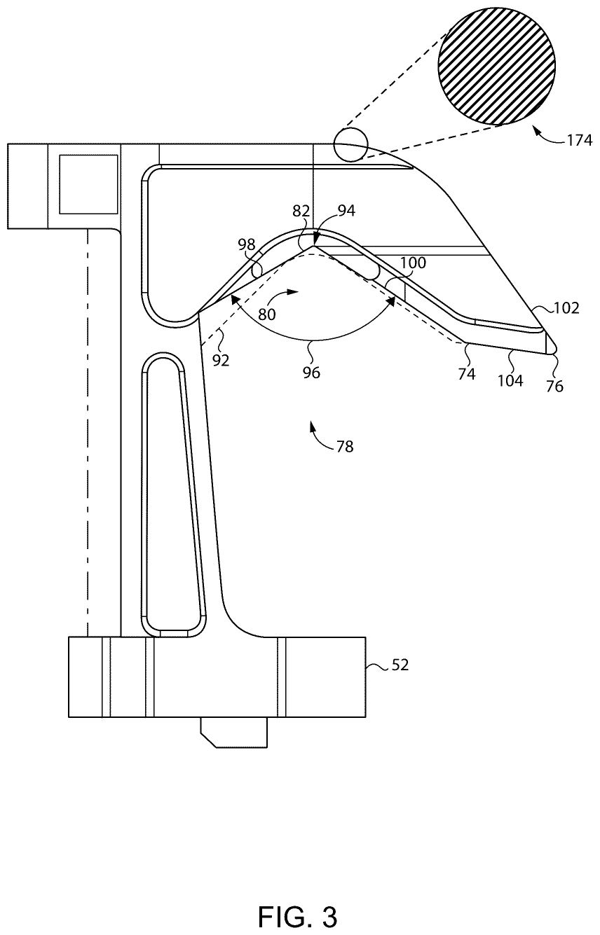

Also now referring to FIG. 3, first jaw 48, hook portion 74, and threaded receiving portion 52, together, open to a throat 78 forming a wire seating pocket 80 for admitting conductors 14. Wire seating pocket 80 may be oriented toward second jaw 50, and may also include a wire seating surface 82 formed therein. Wire seating pocket 80 may also taper inwardly to form a sharp V-shape having as a vertex a point of the sharp V-shape. In a practical implementation, second jaw 50 may form a V-shape in opposition to the V-shape of first jaw 48. As can be seen in FIGS. 1-3, the contoured V-shaped profile of each jaw 48,50 is formed such that a cradle-like space is formed therebetween to securely hold conductors 14 of different sizes. The angles and radiuses of first jaw 48 and second jaw 50 are structured to allow grounding clamp 10 to adapt to various sized conductors 14.

FIGS. 1 and 2 illustrate two exemplary conductors of varying size, with FIG. 1 illustrating a first conductor 84 of a larger diameter, and FIG. 2 illustrating a second conductor 86 of a smaller diameter. As suggested above, the V-shaped design can prevent the larger diameter conductor 84 from moving within wire seating pocket 80, thereby reducing unwanted motion. Without being bound by theory, the V-shaped design can also enhance grip on both larger diameter conductors 84 and smaller diameter conductors 86 by providing two respective lines of contact 88,90 for a more secure hold. FIG. 3 depicts grounding clamp 10 with solid lines and uses dashed lines to illustrate the profile of a different, non-V-shaped wire seating pocket 90 for comparison.

Wire seating surface 82 may define a radius 94 of less than 0.625 inches, in some embodiments less than 0.01 inches, and in still other embodiment smaller still, such as less than 0.006 inches. Additionally, wire seating surface 82 may also include an arcuate theoretical sharp point of the V-shape having a radius ranging from about 0.0005 inches to about 0.005 inches in some embodiments. The radius of wire seating surface 82 may be the smallest radius of all radiuses defined by wire seating pocket 90, and may be the smallest radius of all radiuses defined by all external surfaces of first jaw 48 and second jaw 50 in some embodiments. It should be appreciated that the geometry including dimensions of surfaces of wire seating pocket 80 may vary based on need or method of manufacture. It should also be noted that the term “about,” as used in the present discussion, is intended to mean generally or approximately, as would be understood by one of ordinary skill in the art, such as within measurement error, conventional rounding, or another acceptable tolerance that would be understood by a person of ordinary skill in the grounding clamp arts.

Wire seating surface 82 is located between a first side pocket surface 98 and a second side pocket surface 100. In this arrangement, first side pocket surface 98 may be disposed at an angle 96 relative to second side pocket surface 100. For example, first side pocket surface 98 may be oriented at an angle of 100° or greater relative to second side pocket surface 100. In another example, first side pocket surface 98 at extends about 120° from second side pocket surface 100. Hook portion 74 may include an outer hook surface 102, and an inner hook surface 104 connected to second side pocket surface 98, and extending outwardly and downward toward threaded receiving portion 52. Put differently, inner hook surface 104 extends from second side pocket surface 98 to terminal tip 74, and is oriented obliquely to clamp axis 68.

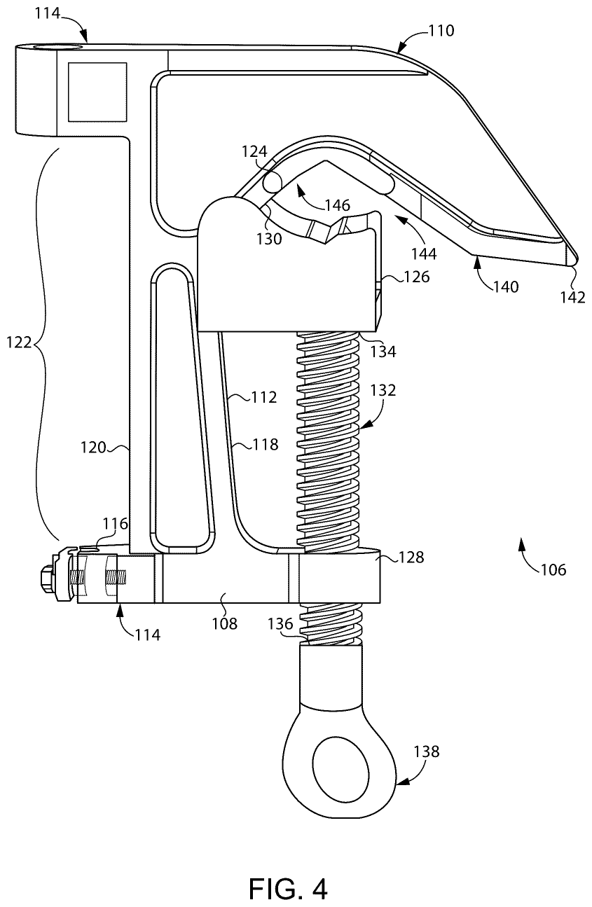

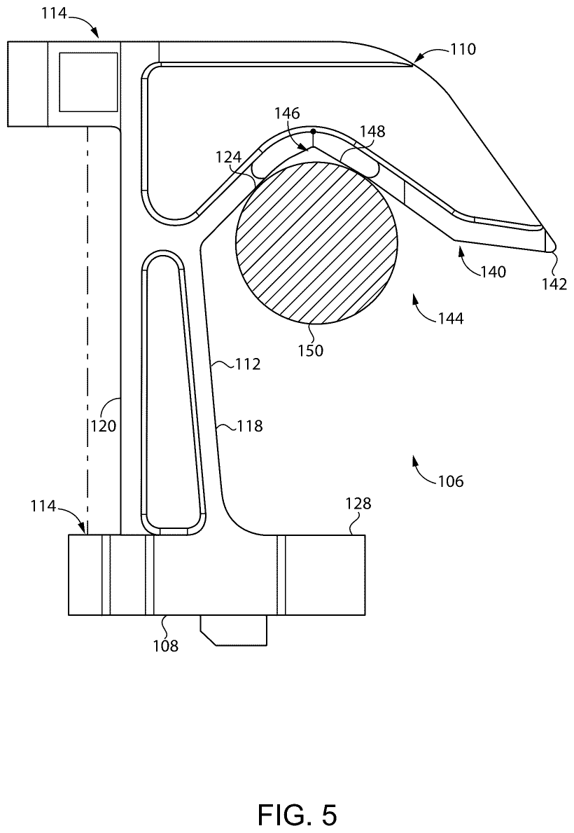

Now referring to FIGS. 4 and 5, there is shown a grounding clamp 106 according to another embodiment. It should be appreciated that the forthcoming description of grounding clamp 106 should be considered analogous to that of grounding clamp 10, except where specified otherwise. Grounding clamp 106 includes a grounding clamp body 108 having a frame 110. Frame 110 includes a spine portion 112, and at least one grounding terminal 114 coupled to spine portion 112. Grounding terminal 114 may include a through-hole 116. Spine portion 112 may include an inner spine surface 118, and an outer spine surface 120 extending a length of a clearance distance 122. Grounding clamp body 108 may also include a first jaw 124 connected to spine portion 112. Grounding clamp 106 further includes a second jaw 126, and a threaded receiving portion 128. Second jaw 126 may include a frame capture feature 130 which allows second jaw 126 to move along frame 110. Grounding clamp 106 may also include a threaded rod 132 structured to move second jaw 126 relative to the first jaw 124. Threaded rod 132 may include a first rod end 134, a second rod end 136, and a coupling eye 138. Grounding clamp body 108 also includes a hook portion 140 connected to first jaw 124 and extending to a terminal tip 142. Grounding clamp 106 also opens to a throat 144 forming a wire seating pocket 146. Wire seating pocket 146 may be oriented toward second jaw 126, and may also include a wire seating surface 148 formed therein.

Now turning to distinctions between grounding clamp 106 and grounding clamp 10, wire seating pocket 146 includes a compound pocket configuration. It should be appreciated that the term “compound pocket,” as used herein denotes a pocket structure that includes multiple surfaces that can be arranged at various angles relative to each other. It should further be appreciated that the arrangement of this compound pocket configuration may enable grounding clamp 106 to accommodate a broad range of conductors 150, for example, certain known conductors, commonly used conductors, or still conductors of different sizes. Additionally, the angles and radii of this compound pocket configuration may facilitate this adaptation to different conductor sizes.

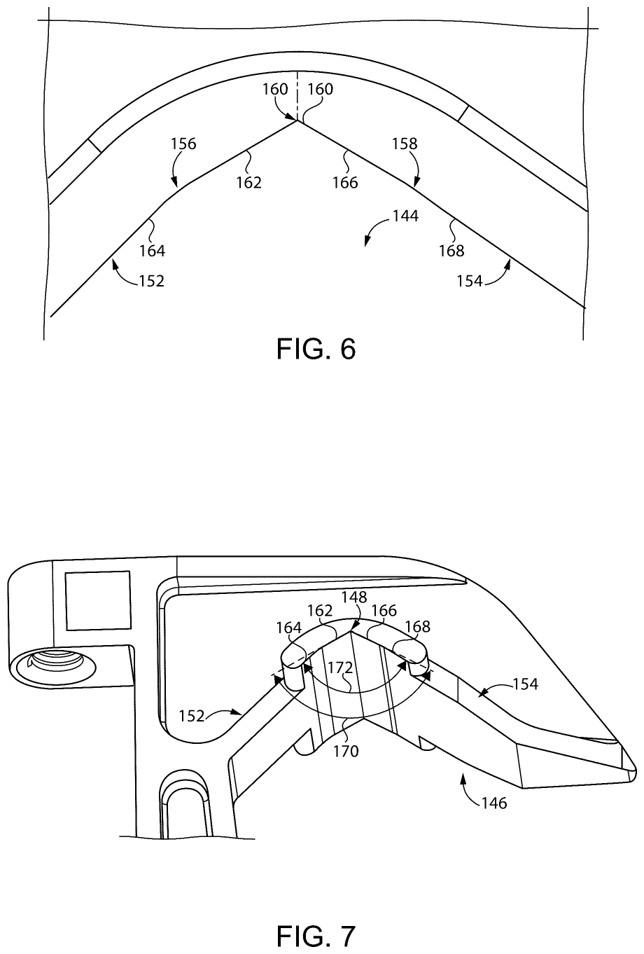

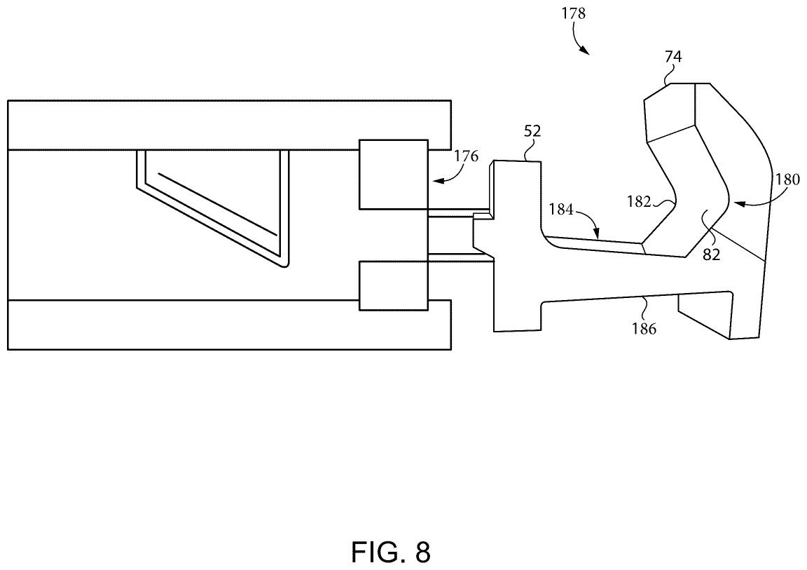

Referring also now to FIGS. 6 and 7, grounding clamp 106 may include a first side 152 and a second side 154 tapering inwardly to form a sharp V-shape having as a vertex a point of the sharp V-shape. In this embodiment, wire seating pocket 148 may include a first radius 156, a second radius 158, and a third radius 160. First radius 156 may be located toward first side 152 and second radius 158 may be located toward second side 154. As shown, both first radius 156 and second radius 158 are located outwardly relative to a theoretical sharp point of the V-shape. Also as can be seen in FIGS. 6 and 7, first side 152 and second side 154 may form an asymmetrical sharp V-shape having left-right asymmetry. It should be appreciated that first radius 156 and second radius 158 could be the same on each side 152,154 or different. In a practical implementation, first radius 156 may be, for example, less than 0.625 inches, analogous to the embodiment discussed above. Second radius 158 and third radius 160 may be equal in size, and each larger than first radius 156. In a manner akin to grounding clamp 10, third radius 160 may be located at the arcuate theoretical sharp point of the V-shape, and may range from about 0.0005 inches to about 0.005 inches in some embodiments.

Wire seating pocket 146 also includes a first inner surface 162 and a first outer surface 164 located at first side 152, and a second inner surface 166 and a second outer surface 168 located at second side 154. A first angle 170 may be defined between first inner surface 162 and second inner surface 166, and a second angle 172 may be defined between the first outer surface 164 and the second outer surface 168. It should be appreciated that first angle 170 and the second angle 172 could be the same or different. In a practical implementation, first angle 170 may be greater than second angle 172. For example, first inner surface 162 may be oriented at an angle 170 of about 120° relative to second inner surface 166. In another example, first outer surface and second outer surface may be oriented at an angle 172 of about 100°.

### INDUSTRIAL APPLICABILITY

It will be recalled that grounding clamp 10 may be made by way of extrusion, including extrusion of aluminum and/or aluminum alloys. It should be understood that grounding clamp 10 may include separate extrusions for first jaw 48 and second jaw 50 allowing for independent fabrication of each. As shown in FIG. 3, a grain structure 174 of grounding clamp body 12 demonstrates the inherent characteristics of extruded metal material, namely aluminum, with finer grains generally aligned in a direction of extrusion. Referring also now to FIG. 4, making grounding clamp 10 may include extruding a material through a die 176 to form an extrusion body 178 having a shape including a jaw portion 180 and a pocket portion 182. Making grounding clamp 10 may also include forming from extrusion body 178 a grounding clamp blank, for example, receiving a grounding clamp blank as a complete extrusion or cutting a section from extrusion body 178 to form grounding clamp blank 184.

Making grounding clamp 10 may also include forming a profile of pocket portion 182 in grounding clamp blank 184 so as to include wire seating surface 84 defining a radius that is less than 0.65 inches. Wire seating surface 84 can be machined further to reduce the radius to a specified dimension, such as 0.01 inches or less as discussed herein. Making grounding clamp 10 may further include machining grounding clamp blank 184 so as to form a grounding clamp blank body 186 having a first jaw 48 and wire seating pocket 80 that includes arcuate wire seating surface 84.

It should be appreciated that a variety of machining processes are contemplated herein, for example, milling, grinding, electrostatic discharge machining, and still other machining processes. Machining the grounding clamp blank 184 may also include forming threaded receiving portion 52 and hook portion 74, and opening 78 formed together with threaded receiving portion 52, first jaw 48, and hook portion 74. Making grounding clamp 10 may further include installing threaded rod 56 and coupling second jaw 50 thereto. As noted elsewhere, the dimensions of wire seating pocket 80 may vary based on need or the method of manufacture.

Extruding, as discussed herein, may provide certain benefits to a machinable blank well-suited for the formation of small radiuses and other sharp, detailed structures, especially when compared to casting or other techniques. The more uniform and generally aligned grain structure typical of extrusion tends to be less prone to cracking, particularly around complex features like small radiuses such as that defined by wire seating pocket 80. Such properties contrast with casted parts which are typically characterized by higher porosity, less uniform grain structure, and potentially other differences that would render forming very small radiuses, particularly in a V-shaped wire seating structure impracticable or otherwise undesirable.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A grounding clamp comprising:
a grounding clamp body including a first jaw, a threaded receiving portion, at least one grounding terminal, and a second jaw structured to cooperate with the first jaw to clamp a conductor therebetween;
the first jaw including a wire seating pocket opening toward the second jaw, and a wire seating surface within the wire seating pocket and connected to a first side pocket surface and a second side pocket surface; and
wherein the wire seating surface defines a radius less than 0.625 inches.

2. The grounding clamp of claim 1 wherein the wire seating surface forms a sharp V-shape, and the first side pocket surface and the second side pocket surface define an angle therebetween having as a vertex a point of the sharp V-shape.

3. The grounding clamp of claim 2 wherein the angle between the first side pocket surface and the second side pocket surface is about 100° or greater.

4. The grounding clamp of claim 3 wherein the wire seating pocket is a compound pocket, and the wire seating surface defines a second radius.

5. The grounding clamp of claim 1 wherein the second jaw forms a second wire seating pocket arranged in opposition to the first wire seating pocket.

6. The grounding clamp of claim 1 wherein:
the at least one grounding terminal includes a first grounding terminal at a first clamp end, and a second grounding terminal at a second clamp end, and a clearance is defined between the first grounding terminal and the second grounding terminal; and
the clearance defines a clearance distance, and the second jaw is movable a travel distance between a fully opened position and a fully closed position that is less than the clearance distance.

7. The grounding clamp of claim 1 further includes a threaded rod through the threaded receiving portion, and rotatable to move a position of the second jaw relative to the first jaw.

8. The grounding clamp of claim 1 wherein the radius is less than 0.01 inches.

9. The grounding clamp of claim 1 further including a hook portion having a terminal tip extending obliquely to a clamp axis, and the wire seating surface is positioned upwardly from the terminal tip.

10. A grounding clamp comprising:
a grounding clamp body including a threaded receiving portion, at least one grounding terminal having a through-hole for receiving a grounding wire, and a frame having a spine portion;
the grounding clamp body further including a jaw connected to the spine portion, and the jaw having a hook portion extending outwardly to a terminal tip; and
the grounding clamp body further forming a wire clamping pocket extending between the spine and the hook portion, and a wire seating surface within the wire clamping pocket and forming a V-shape.

11. The grounding clamp of claim 10 wherein the wire seating surface defines a radius less than 0.01 inches.

12. The grounding clamp of claim 11 wherein the wire seating pocket opens to a throat extending from the spine portion to the terminal tip of the hook portion and structured for admitting a wire into the wire seating pocket.

13. The grounding clamp of claim 11 wherein the V-shape includes a sharp V-shape, having a first side pocket surface and a second side pocket surface defining an angle therebetween that is about 100° or greater.

14. The grounding clamp of claim 13 wherein the first side pocket surface and the second side pocket surface taper inwardly, such that the hook portion is in communication with the wire seating pocket.

15. The grounding clamp of claim 13 wherein the wire seating pocket is a compound pocket.

16. The grounding clamp of claim 13 further including a second jaw structured to cooperate with the first jaw to form a connection with a conductor therebetween, the second jaw forming a V-shape in opposition to the V-shape formed by the wire seating surface.

17. The grounding clamp of claim 10 wherein the grounding clamp body is an extrusion.

18. A method of making a grounding clamp comprising;
extruding a material through a die to form an extrusion body having a shape including a jaw portion and a pocket portion;
forming from the extrusion a grounding clamp blank;
forming a profile of the pocket portion in the grounding clamp blank so as to include a wire seating surface defining a radius of 0.625 inches or less;
machining the grounding clamp blank so as to form a grounding clamp body having a first jaw and a wire clamping pocket that includes the wire seating surface; and
installing a threaded rod coupled to a second jaw in the grounding clamp body.

19. The method of claim 18 wherein forming from the extrusion a grounding clamp blank further includes forming a hook portion and a spine portion, and wherein the pocket portion is between the hook portion and the spine portion.

20. The method of claim 18 wherein the wire seating surface forms a V-shape, and is positioned between a first side pocket surface and a second side pocket surface together defining an angle of about 120°.
